(19) United States
(12) Patent Application Publication
(10) Pub. No.: US 2014/0232099 A1
(43) Pub. Date: Aug. 21, 2014

(54) BINDING SYSTEM USING TWO BINDING PIECES

(71) Applicant: Eric Peschan Hochreiter, Rochester, NY (US)

(72) Inventor: Eric Peschan Hochreiter, Rochester, NY (US)

(21) Appl. No.: 13/769,923

(22) Filed: Feb. 19, 2013

(51) Int. Cl. B42D 1/00

(52) U.S. Cl. CPC B42D 1/00
USPC 281/21.1

(57) ABSTRACT

A binding system for binding a set of media sheets, including top and bottom binding pieces. Each binding piece includes a base plate, together with alignment features adapted to align the top and bottom binding pieces with each other, and locking features adapted to connect the top and bottom binding pieces together, thereby clamping the media sheets between the top and bottom binding pieces. The locking features include resilient tabs having a plurality of teeth such that at least some of the teeth on a particular tab on the top binding piece engage with at least some of the teeth on a corresponding tab on the bottom binding piece to connect the top and bottom binding pieces together.

### CROSS-REFERENCE TO RELATED APPLICATIONS

Reference is made to commonly assigned, co-pending U.S. patent application Ser. No. ______ (Docket K001375), entitled: “Binding system using concentric cylinders”, by Hochreiter et al.; to commonly assigned, co-pending U.S. patent application Ser. No. ______ (Docket K001448), entitled: “Binding system using binder pieces with concentric cylinders”, by Hochreiter et al.; and to commonly assigned, co-pending U.S. patent application Ser. No. ______ (Docket K001449), entitled: “Binding system using arc-shaped retainer”, by Hochreiter et al.; to commonly assigned, co-pending U.S. patent application Ser. No. ______ (Docket K001376), entitled: “Binding system using a retainer clip”, by Hochreiter; and to commonly assigned, co-pending U.S. patent application Ser. No. ______ (Docket K001457), entitled: “Binding system using one-piece retainer clip”, by Hochreiter, each of which is incorporated herein by reference.

### FIELD OF THE INVENTION

This invention pertains to the field of book binding and more particularly to a system for binding a set of sheets for a photo book.

### BACKGROUND OF THE INVENTION

In recent years, the proliferation of digital photography has provided consumers with a variety of options to store and use captured images. These options include various “soft copy” methods involving memory cards, memory sticks, CD's, DVD's, hard drives, on-line storage etc. These “soft-copy” options, while providing the environmental benefit of eliminating the paper, ink or dye, and other chemicals required for “hard-copy” output, are potentially less secure for long term storage due to media format obsolescence, storage media physical or chemical breakdown, and on-line storage companies disappearing. A variety of options exist for customers to print digital images, including conventional silver halide processing, ink jet, thermal dye transfer, and electrophotographic methods. These “hard-copy” methods are capable of providing printed output which can last for many decades. Although customers can make such “hard-copy” prints at home, modern retail outlets provide kiosks and order-terminals where both prints and additional services can be requested and provided. Similar services are also available from on-line companies such as Shutterfly. An increasingly popular service provides photo albums or photo books with collections of images associated with a specific event, such as a vacation, family gathering, school function etc. The photo books are composed of printed images produced by any one of the printing methodologies described above that are bound together in book form.

Photo books can be constructed in various formats. For example, single sheets of printed material bearing an image on one side of the material can be bound together to form the photo books. Such photo books are generally less preferred as each printed page of the book will face a blank page (i.e. the non-printed backside of another printed page). This disadvantage can be eliminated by adhering together sheets of single-side printed media to produce a double-sided album page as disclosed in U.S. Pat. No. 5,791,692, U.S. Pat. No. 5,957,502, U.S. Pat. No. 6,004,061 and U.S. Pat. No. 7,047,683. U.S. Pat. No. 6,742,809 describes a strip of images folded in accordion manner such that each pair of adjacent images forms two sides of a page, the accordion folds being adhered together on the inside. Photo books produced by adhering two imaged prints together are typically thicker than single-sided sheet products, and this can result in a heavy and bulky product when the photo book contains a large number of pages.

The pages of printed images can be bound together in a variety of different ways to fabricate the photo books. Techniques known in the art for constructing photo books include binding the pages together using binder clips, staples, adhesive, stitching or ring binders. These methods vary widely in the attractiveness and durability of the resulting photo book, as well as the equipment and operator skill level required during the fabrication process. Generally, the methods to produce the most attractive and durable photo books have required expensive components or complex binding equipment operated by highly-trained operators. This has made it impractical to produce photo books in retail environments that offer photo printing services using photo kiosks.

U.S. Pat. No. 5,061,139 to Zoltner, entitled “Method for applying hard and soft covers to bound or unbound documents,” discloses a bindery system for applying hard or soft covers to form bound books. The system includes a metal U-shaped channel which is bonded to the inside spine surface of the cover. Specialized equipment is used to crimp the U-shaped channel to bind the book pages.

A number of different binding systems have been proposed that utilize spring clamp mechanisms. U.S. Pat. No. 5,716,181 to Ebel, entitled “One piece self-binding system for binding documents,” discloses a binding system for use in a home environment that utilizes a spring binding to clamp pages into a bound book. A retaining piece is provided to hold the spring binding open until the pages are in place. The retaining piece is removed to clamp the pages into the book cover. U.S. Pat. No. 7,757,358 to Hoarau et al., entitled “Sheet retention mechanisms for spring clamp binders,” discloses a system for binding pages together using a spring clamp mechanism. U.S. Pat. No. 7,798,736 to Hoarau et al., entitled “Media binder arrangements,” discloses a media binder that includes spine clamps for securing the media pages. A tension sheet is used to transmit an opening force to the spine clamp. The components of such systems are generally too expensive and complex to be useful for producing low-cost photo books in a retail environment.

U.S. Pat. No. 3,866,274 to Malavazos et al., entitled “Device for binding sheets,” discloses a device for binding a plurality sheets that comprise a pair of identical binding members, each of which includes a base member and a plurality of binding posts. The binding posts are inserted through apertures on the other binding member. Each binding post has a continuous series of ratchet teeth adapted to engage with the ratchet teeth on a corresponding binding post on the other binding member. This approach has the disadvantage that after the binding pieces are assembled, a cutting device must be used to shave off the portion of the binding posts that protrude from the outer face of the base members.

U.S. Pat. No. 5,690,443 to Sullivan et al., entitled “Adjustable, releasable binding fastener,” discloses a fastening device having male and female fastener portions for binding a stack of paper. The female fastener portion includes a planar base having an aperture and an arcuate shaped collar with ratchet teeth facing the aperture on two opposing sides. The male fastener portion includes a post extending perpendicularly from a planar base. The post includes ratchet teeth adapted to engage with the ratchet teeth on the female fastening device when the post is inserted into the collar.

French patent document FR2668981A1 to Bourdarias discloses a device for assembling sheets into a packet. It comprises a pair of identical pegs, each having one side formed into a series of teeth. The pegs are designed to be inserted head-to-tail in a hole running through the sheets, the toothed sides being placed against each other. The total cross-section of the two juxtaposed pegs fits closely inside that of the hole. Each peg has a head which stops against one side of the packet.

There remains for a low-cost method to bind a set of sheets to form an attractive and durable photo book without the need for special purpose equipment or highly-trained operators.

### SUMMARY OF THE INVENTION

The present invention represents a binding system for binding a set of media sheets, comprising:

a top binding piece and a bottom binding piece, each including:
a base plate;
alignment features adapted to align the top and bottom binding pieces with each other; and
locking features adapted to connect the top and bottom binding pieces together around one edge of the set of media sheets, thereby clamping the media sheets between the top and bottom binding pieces, the locking features including at least one resilient tab having a plurality of teeth;

wherein when the top and bottom binding pieces are pushed together to bind the set of media sheets, at least some of the teeth on a particular tab on the top binding piece engage with at least some of the teeth on a corresponding tab on the bottom binding piece to connect the top and bottom binding pieces together; and

wherein when the top and bottom binding pieces are connected together to bind the set of media sheets, the locking features are contained between external surfaces of the base plates of the top and bottom binding pieces.

This invention has the advantage that the binding system is easy to assemble and can be used to produce photo books without the need for specialized equipment or highly-trained operators. As a result, it is particularly appropriate for use in retail or home environments.

It has the additional advantage that the binding system automatically adapts to accommodate a different number of media sheets.

It has the further advantage that the binding pieces provide an attractive spine for the bound book.

### BRIEF DESCRIPTION OF THE DRAWINGS

FIG. 1 shows the components of a binding system according to an exemplary embodiment;

FIG. 2 shows the binding system of FIG. 1 in a partially-assembled state;

FIG. 3 shows the binding system of FIG. 1 in a fully-assembled state;

FIG. 4 shows a cross-sectional cut through the assembled binding system of FIG. 3 at the cut line A-A′;

FIG. 5 shows posts that incorporate locking features according to an alternate embodiment; and

FIG. 6 shows a binding system according to an alternate embodiment.

It is to be understood that the attached drawings are for purposes of illustrating the concepts of the invention and may not be to scale.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Commonly-assigned U.S. Patent Application Publication No. 2012/0248753 to Mindler, entitled “Binder clip,” and the related U.S. Patent Application Publication No. 2012/0251269 to Mindler, entitled “Binder clip,” both of which are incorporated herein by reference, describe a binding system that can be used to bind printed media sheets into a book (e.g., a photo book). The binding system includes a binder clip having flexible sidewalls biased to close around a rigid retainer for securing pages wrapped around the retainer or pinched by the binder clip and retainer to manually form a book.

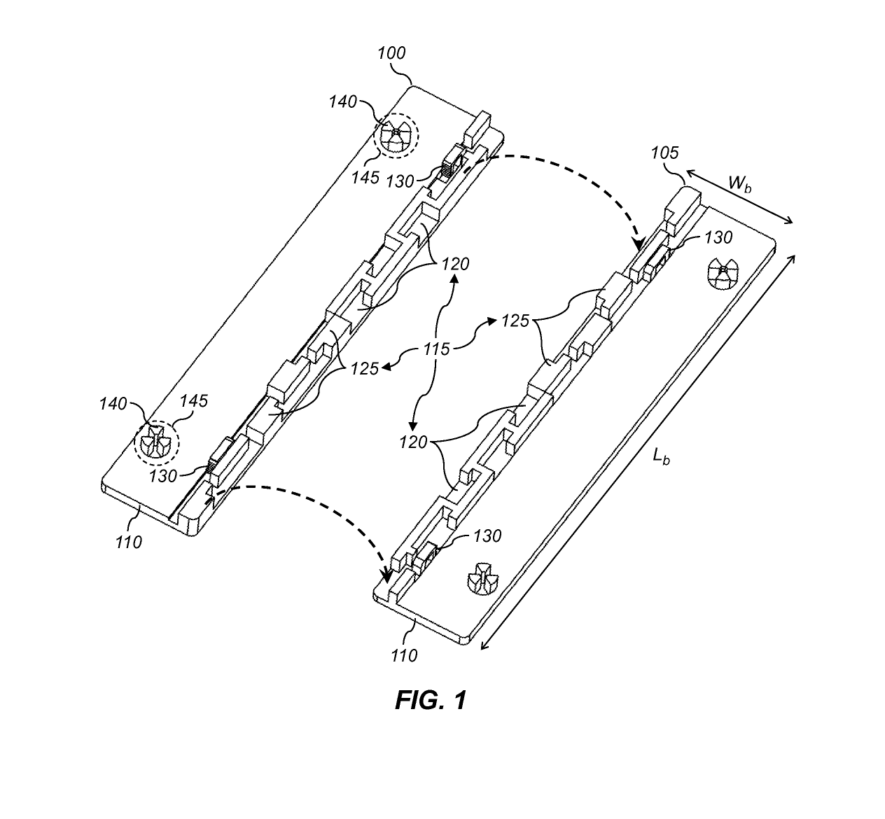

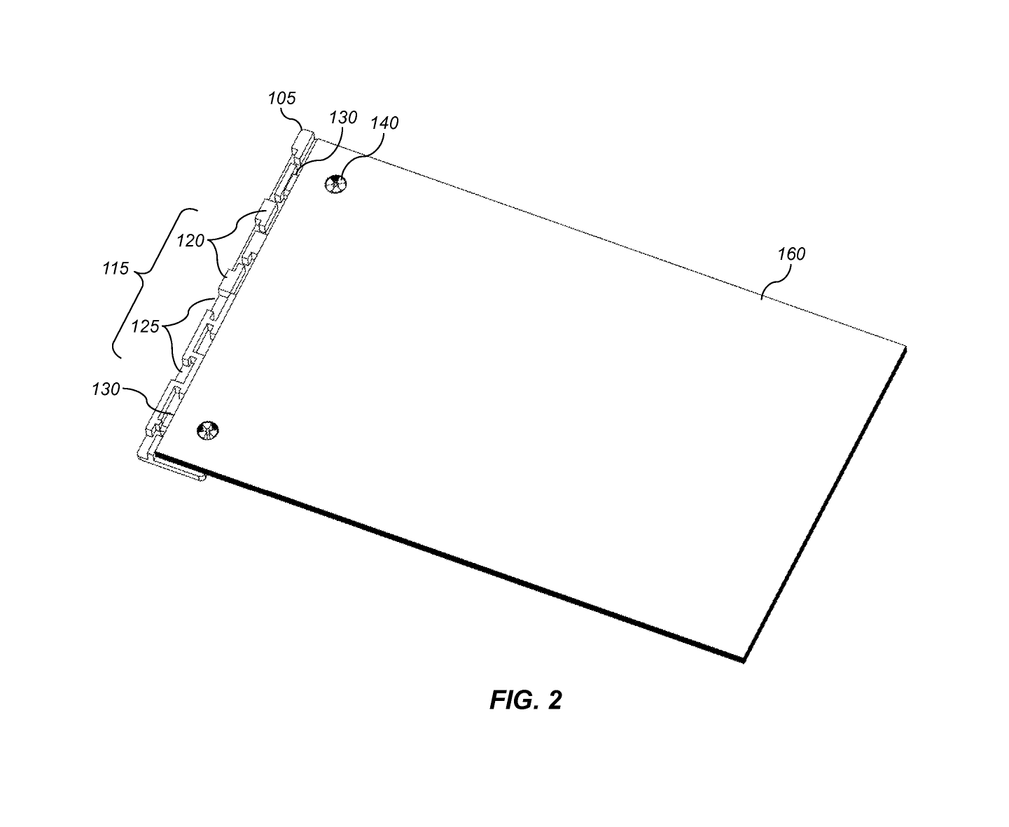

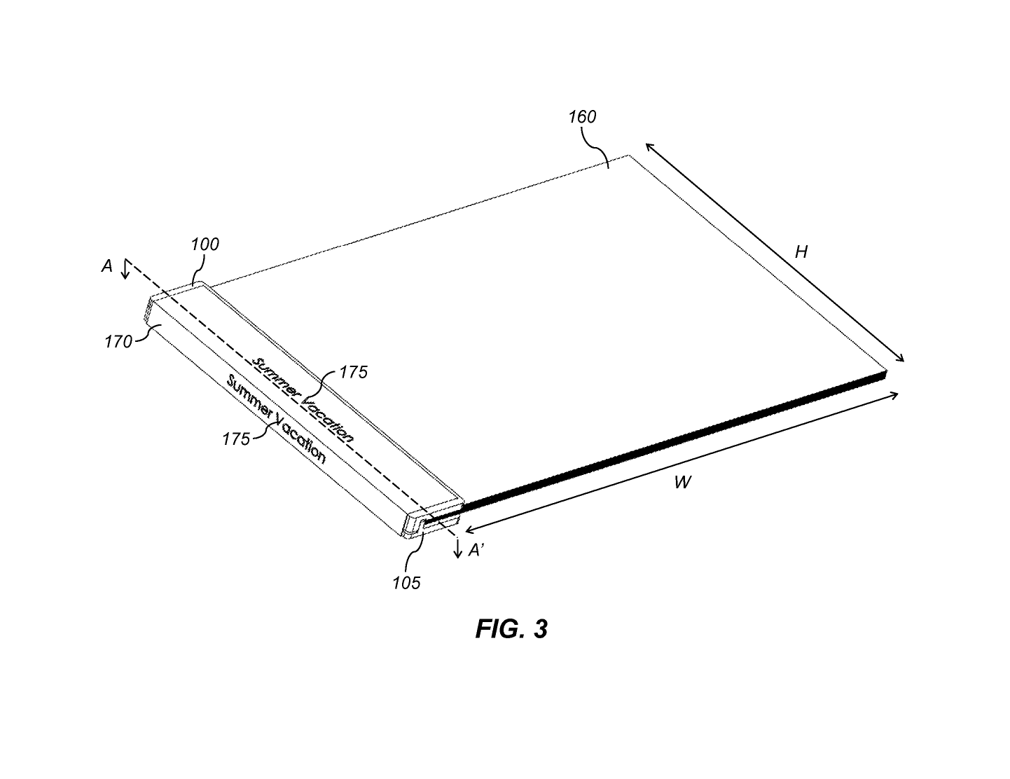

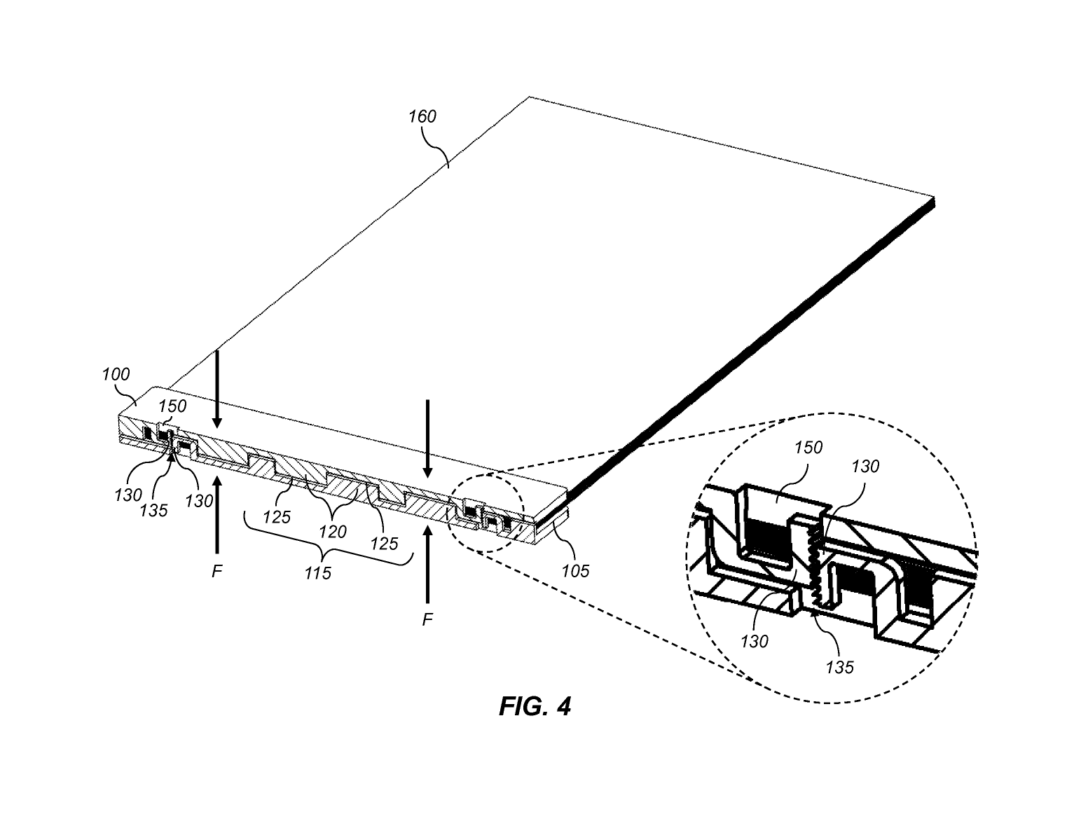

FIGS. 1-4 illustrate a binding system for binding a set of media sheets 160 according to an exemplary embodiment of the present invention. FIG. 1 shows the components of the binding system, which include a top binding piece 100 and a bottom binding piece 105. FIG. 2 shows the binding system of FIG. 1 in a partially-assembled state, and FIG. 3 shows the binding system of FIG. 1 in a fully-assembled state. FIG. 4 shows a cross-sectional cut through the fully-assembled binding system of FIG. 3 at the cut line A-A′.

The top binding piece 100 and the bottom binding piece 105 each include a base plate 110, together with alignment features 115 (i.e., protruding alignment features 120 and protrusion receiving alignment features 125) and locking features 130. The top binding piece 100 and the bottom binding piece 105 also include optional posts 140 adapted to be inserted through holes in the media sheets 160. The binding system is adapted to bind the set of media sheets 160 by positioning the media sheets 160 onto the bottom binding piece 105 as shown in FIG. 2. The top binding piece 100 is then aligned with the bottom binding piece 105 and pressed down to engage the locking features 130, thereby connecting the top binding piece 100 and the bottom binding piece 105 together to bind the set of media sheets 160 as shown in FIG. 3.

The size of the top binding piece 100 and the bottom binding piece 105 are given by binding piece length L_{b} and a binding piece width W_{b}. In a preferred embodiment, the media sheets 160 have a height dimension (i.e., book page height H) that is substantially the same as the binding piece length L_{b}. The exposed portion of the media sheets 160 has a width dimension (i.e., book page width W) that defines the size of the bound book.

The alignment features 115 are adapted to align the top binding piece 100 and the bottom binding piece 105 with each other. The alignment features 115 on the top binding piece 100 and the bottom binding piece 105 are designed so that the alignment features 115 only fit together with each other when the pieces are in proper alignment. In particular, protruding alignment features 120 on the top binding piece 100 are adapted to be inserted into corresponding protrusion receiving alignment features 125 on the bottom binding piece 105. Likewise, protruding alignment features 120 on the bottom binding piece 105 are adapted to be inserted into corresponding protrusion receiving alignment features 125 on the top binding piece 100. In a preferred embodiment, the alignment features 115 are adapted so that they can be inserted to different extents to accommodate a different number of media sheets 160.

The locking features 130 are adapted to connect the top binding piece 100 and the bottom binding piece 105 together around one edge of the set of media sheets 160, thereby clamping the media sheets 160 with a clamping force F. The locking features 130 are preferably positioned in the interior of the top binding piece 100 and the bottom binding piece 105. That is, the locking features 130 are on the side of the base plate 110 that faces the bound media sheets 160, and they are not located on the perimeter of the base plate 110. In this way, when the pieces are connected together to bind the set of media sheets 160, the locking features 130 are contained between external surfaces of the base plates 110 of the top binding piece 100 and the bottom binding piece 105. This hides the locking features 130 from view between the base plates 110, thereby improving the aesthetic appearance.

In a preferred embodiment, the locking features 130 include a resilient tab having a plurality of teeth 135 (FIG. 4). As the top binding piece 100 and the bottom binding piece 105 are pushed together, the resilient tabs flex, allowing the teeth 135 to slide by each other so that at least some of the teeth 135 on a particular tab on the top binding piece 100 engage with at least some of the teeth 135 on a corresponding tab on the bottom binding piece 105, thereby locking the pieces together. The number of teeth 135 on the particular tab on the top binding piece 100 that are engaged with the teeth 135 on the corresponding tab on the bottom binding piece 105 will depend on the number of media sheets 160 that are being bound together. If more media sheets 160 are bound, the top binding piece 100 cannot be inserted as far into the bottom binding piece 105, and therefore fewer teeth 135 on the locking features 130 will be engaged. Conversely, if less media sheets 160 are bound, the top binding piece 100 can be inserted further into the bottom binding piece 105, and therefore more teeth 135 on the locking features 130 will be engaged. In this way, the binding system automatically adapts to accommodate a different number of media sheets.

In some embodiments, access holes 150 can be provided in the base plate 110 as illustrated in FIG. 1. The access holes 150 can provide access to the locking features 130 so that a user can pull back the resilient tabs to disengage the teeth 135, thereby enabling the top binding piece 100 and the bottom binding piece 105 to be disassembled to remove some media sheets 160, or add additional media sheets.

In a preferred embodiment, the top binding piece 100 and the bottom binding piece 105 are designed to be identical to each other. This has the advantage of reducing manufacturing and inventory costs. This can be accomplished by designing the alignment features 115 and the locking features 130 in complementary arrangements so that when a bottom binding piece 105 is flipped over it can be used as a top binding piece 100. When this condition is satisfied, the alignment features 115 in the top binding piece 100 (i.e., the inverted bottom binding piece) fit together with corresponding alignment features 115 in the bottom binding piece 105, and the locking features 130 in the top binding piece 100 (i.e., the inverted bottom binding piece) connect with corresponding locking features 130 in the bottom binding piece 105. The complementary arrangement can be provided by making the protruding alignment features 120 on the top half of the bottom binding piece 105 to be a mirror image of the protrusion receiving alignment features 125 on the bottom half of the bottom binding piece 105, and vice versa. Similarly, the locking features 130 on the top half of the bottom binding piece 105 are designed to engage with the locking features 130 on the bottom half of the bottom binding piece 105 when the piece is flipped over to use it as the top binding piece 100.

In some embodiments, the top binding piece 100 and the bottom binding piece 105 include posts 140 adapted to be inserted through holes in the media sheets 160. The posts 140 provide a mechanism for locking the media sheets 160 in position in the bound book so that they cannot be easily pulled out from between the connected binding pieces. In the illustrated embodiment, two holes are punched through each of the media sheets 160, and corresponding posts 140 are provided that are positioned to be inserted through the holes. It will be obvious to one skilled in the art that different numbers, positions, shapes and sizes of holes can be used in accordance with different embodiments.

Preferably, the posts 140 are provided in a complementary arrangement so that the top binding piece 100 and the bottom binding piece 105 can be identical to each other. In the illustrated exemplary embodiment, this is accomplished by providing two groups of posts 145 corresponding to the two holes in the media sheets 160, each post 140 having a cross-section corresponding to a sector of the circular hole in the media sheets 160. Each group of posts 145 includes three individual posts 140 corresponding to sectors of substantially 60° that are in complementary positions to the posts 140 in the other group of posts 145. In this way, when a bottom binding piece 105 is flipped over to use it as a top binding piece 100, the posts 140 fit together in an interleaved fashion when the pieces are properly aligned. In this way, the posts 140 also function as additional alignment features 115.

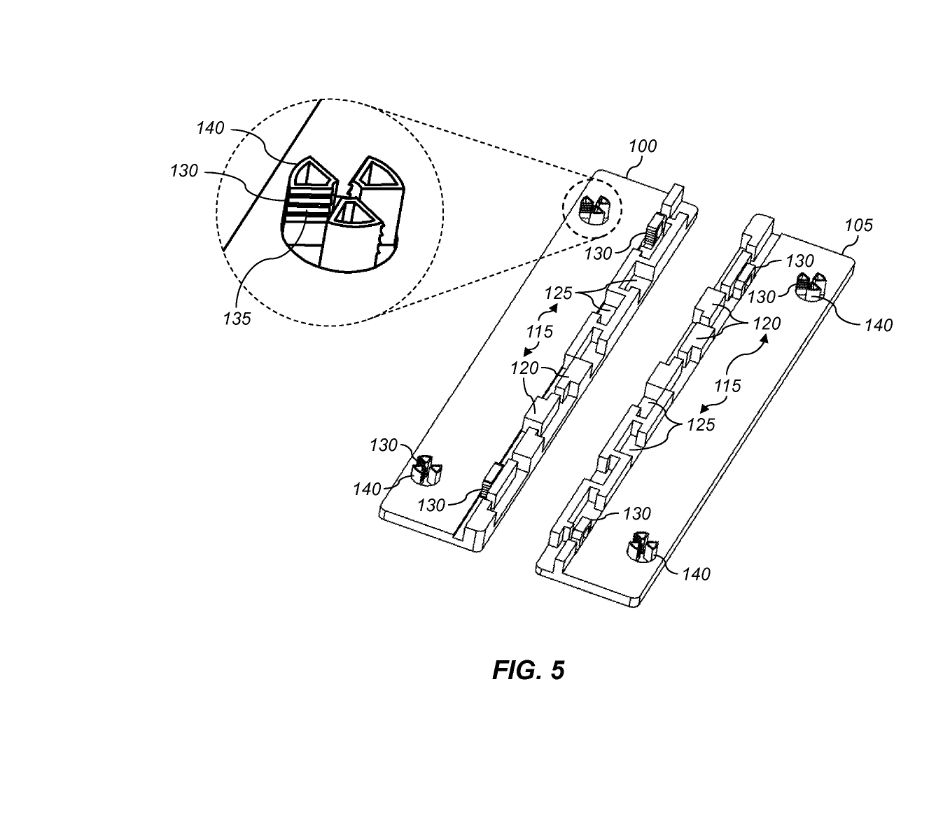

In some embodiments, locking features 130 can be incorporated into the posts 140. For example, resilient tabs with teeth 135 can be incorporated into one or more of the side surfaces of the posts 140 as illustrated in FIG. 5. As the posts 140 on the top binding piece 100 are inserted between the posts 140 on the bottom binding piece 105, the resilient tabs flex, allowing the teeth 135 to slide by each other so that at least some of the teeth 135 on a particular post on the top binding piece 100 engage with at least some of the teeth 135 on a corresponding post on the bottom binding piece 105, thereby locking the pieces together.

In some embodiments, a book title 175 or other text/decorative graphics can be provided on one or both of the top binding piece 100 and the bottom binding piece 105 (e.g., on the spine or the front surface of the bound book as illustrated in FIG. 3). The book title 175 can be produced in a variety of different ways. For example, the book title 175 can be printed directly onto the top binding piece 100, or can be printed onto an adhesive label 170 that can be affixed to the exterior of the binding pieces. In the example shown in FIG. 3, the adhesive label is wrapped around an edge of the connected binding pieces opposite to the bound media sheets 160. This has the advantage that the adhesive label 170 hides the alignment features 115 and the locking features 130 from view.

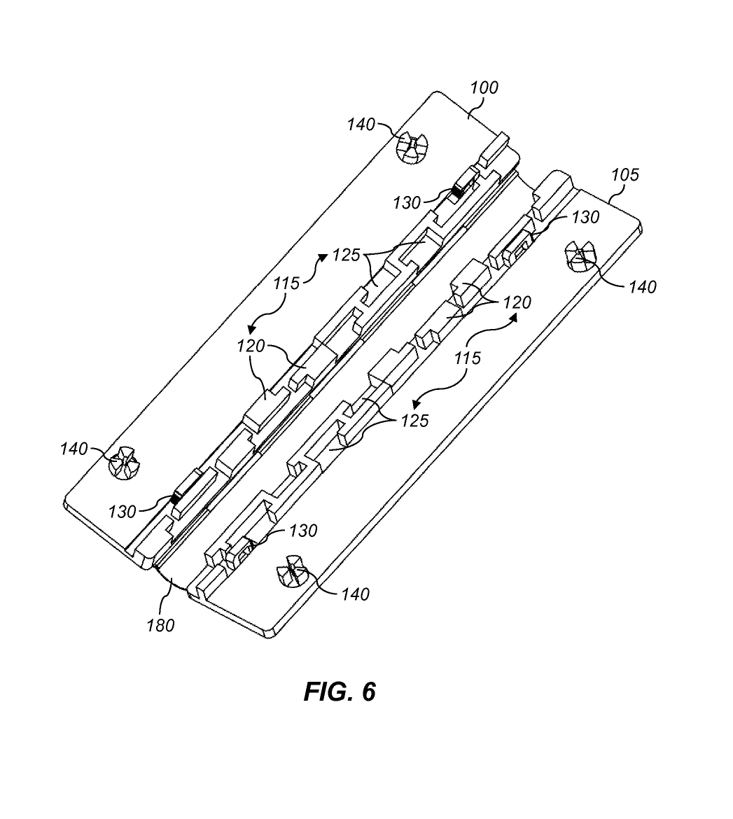

FIG. 6 illustrates an alternate embodiment where the top binding piece 100 and the bottom binding piece 105 are attached to each other using a flexible hinge 180. In this case, the flexible hinge 180 flexes so that the top binding piece 100 can be folded over the top of the bottom binding piece 105 and pressed down to engage the locking features 130, thereby binding the set of media sheets 160 (not shown in FIG. 6). In the illustrated example, the flexible hinge 180 is made from a thin sheet of flexible plastic. In some embodiments, the top binding piece 100, the bottom binding piece 105 and the flexible hinge 180 are made of the same material and are molded as a single piece. This approach provides the advantage that the binding system uses only a single component, rather than requiring two separate pieces as in the embodiment of FIG. 1. Additionally, when the binding system is assembled, the flexible hinge 180 serves the additional function of hiding the alignment features 115 and providing an attractive spine for the bound book.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The invention has been described in detail with particular reference to certain preferred embodiments thereof, but it will be understood that variations and modifications can be effected within the spirit and scope of the invention.

### PARTS LIST

100 top binding piece
105 bottom binding piece
110 base plate
115 alignment features
120 protruding alignment features
125 protrusion receiving alignment features
130 locking features
135 teeth
140 posts
145 group of posts
150 access holes
160 media sheets
170 adhesive label
175 book title
180 flexible hinge
F clamping force
H book page height
L_{b} binding piece length
W book page width
W_{b} binding piece width

1. A binding system for binding a set of media sheets, comprising:
a top binding piece and a bottom binding piece, each including:
a base plate;
alignment features adapted to align the top and bottom binding pieces with each other; and
locking features adapted to connect the top and bottom binding pieces together around one edge of the set of media sheets, thereby clamping the media sheets between the top and bottom binding pieces, the locking features including at least one resilient tab having a plurality of teeth;
wherein when the top and bottom binding pieces are pushed together to bind the set of media sheets, at least some of the teeth on a particular tab on the top binding piece engage with at least some of the teeth on a corresponding tab on the bottom binding piece to connect the top and bottom binding pieces together; and
wherein when the top and bottom binding pieces are connected together to bind the set of media sheets, the locking features are contained between external surfaces of the base plates of the top and bottom binding pieces.

2. The binding system of claim 1 wherein the top and bottom binding pieces are identical, and wherein the alignment features and the locking features are provided in complementary arrangements so that when a bottom binding piece is flipped over it can be used as a top binding piece such that the alignment features in the top binding piece fit together with corresponding alignment features in the bottom binding piece, and the locking features in the top binding piece connect with corresponding locking features in the bottom binding piece.

3. The binding system of claim 1 wherein the number of teeth on the particular tab on the top binding piece that are engaged with the teeth on the corresponding tab on the bottom binding piece depends on the number of media sheets that are being bound together.

4. The binding system of claim 1 wherein the alignment features include protruding features on one or both of the top and bottom binding pieces and protrusion receiving features arranged in corresponding positions on the other binding piece such that when top and bottom binding pieces are in proper alignment the protruding features on one binding piece fit into the corresponding protrusion receiving features on the other binding piece.

5. The binding system of claim 1 wherein one or both of the top and bottom binding pieces include posts adapted to be inserted through holes in the media sheets.

6. The binding system of claim 5 wherein at least some of the posts have cross-sections corresponding to sectors of a circle, and wherein the sector-shaped posts on the top binding pieces are adapted to fit together with the sector-shaped posts on the bottom binding pieces in an interleaved arrangement when the top and bottom binding pieces are connected together to bind the set of media sheets.

7. The binding system of claim 5 wherein at least some of the locking features are incorporated into the posts.

8. The binding system of claim 1 wherein when the top and bottom binding pieces are connected together to bind the set of media sheets, the tabs are hidden between the base plates of the top and bottom binding plates so that they are not visible.

9. The binding system of claim 1 further including an adhesive label affixed to the outer surface of one or both of the top and bottom binding pieces.

10. The binding system of claim 9 wherein the adhesive label hides the alignment features and the locking features from view.

11. The binding system of claim 9 wherein the adhesive label is wrapped around an edge of the top and bottom binding pieces opposite to the bound media sheets.

12. The binding system of claim 9 wherein the adhesive label include a book title or decorative graphics.

13. The binding system of claim 1 wherein the top and bottom binding pieces are attached to each other using a flexible hinge.

14. The binding system of claim 13 wherein the top and bottom binding pieces and the flexible hinge are molded as a single piece.
